(19) United States
(12) Patent Application Publication
(10) Pub. No.: US 2026/0187564 A1
(43) Pub. Date: Jul. 2, 2026

(54) COMPUTER-IMPLEMENTED SYSTEM AND METHOD FOR MANAGING CUSTOMER-SUPPLIER ENGAGEMENT WITHIN SUSTAINABILITY-FOCUSED ENTERPRISE

(71) Applicant: REDWOODS AI INC, Pleasanton, CA (US)

(72) Inventor: Arvind Reddy, Pleasanton, CA (US)

(21) Appl. No.: 19/006,297

(22) Filed: Dec. 31, 2024

(51) Int. Cl. G06Q 10/0637; G06Q 10/0635; G06Q 10/0639; G06Q 10/087; G06Q 30/01

(52) U.S. Cl. CPC G06Q 10/0637; G06Q 10/0635; G06Q 10/06393; G06Q 10/087; G06Q 30/01

(57) ABSTRACT

A computer-implemented systems and methods for managing customer-supplier engagement within sustainability-focused enterprise is disclosed. The computer-implemented system receives request for engaging and managing one or more target user or end-user. The computer-implemented system determines source of importing supplier data from among plurality of data sources based on user requirement. The computer-implemented system determines suppliers complying with user requirement based on set of supplier data parameters. The computer-implemented system determines frequency of engagement for each of determined suppliers based on determined level of engagement. The computer-implemented system obtains required documentation from each of determined suppliers in response to sending a notification to complete engagement process to each of determined suppliers. The computer-implemented system verifies obtained required documentation received from determined one or more suppliers using AI or LLM based validations. The computer-implemented system performs one or more actions corresponding to each of determined suppliers based on results of verification.

### TECHNICAL FIELD

The present disclosure generally relates to enterprise-supplier management and collaboration system and, more specifically, relates to a computer-implemented system for managing a customer-supplier engagement within a sustainability-focused enterprise.

### BACKGROUND

Traditionally, collecting and analyzing supplier information, for example, carbon emission data from suppliers are a cumbersome and manual process, leading to incomplete data, human errors, and a lack of actionable insights. Further enterprises struggle to track and reduce their carbon footprint, especially scope three emissions coming from their suppliers and/or vendors.

Existing methods of supplier engagement for sustainability are inefficient, time-consuming, and require manual data collection. The lack of visibility into supplier sustainability data makes tracking of the carbon footprint difficult for enterprises. Furthermore, Corporate Sustainability Officers (CSOs) may need accurate, actionable insights and effective tools to streamline supplier engagement, manage carbon emissions, and ensure compliance with sustainability pledges. Existing manual reporting methods may be inefficient, error-prone, and lack the intelligence needed for meaningful analysis and prediction of future carbon footprints. Additionally, Small and Medium Enterprises (SMEs) often lack the resources and expertise to engage effectively in sustainability reporting. Hence, it is essential for SMEs to collect, aggregate and report their data independently, for compliance or in response to the request from their customers.

Therefore, there is a need for an improved a computer-implemented system for managing a customer-supplier engagement within a sustainability-focused enterprise to overcome the aforementioned limitations, in addition to providing other technical advantages.

### SUMMARY

This section is provided to introduce certain objects and aspects of the present disclosure in a simplified form that are further described below in the detailed description. This summary is not intended to identify the key features or the scope of the claimed subject matter.

In one aspect, the present disclosure relates to a computer-implemented system for managing a customer-supplier engagement within a sustainability-focused enterprise. The computer-implemented system receives a request for engaging and managing one or more target user or end-user. The request includes user requirements and user preferences. The computer-implemented system further determines a source of importing supplier data from among a plurality of data sources based on the user requirement. The plurality of data sources includes one of external database, a locally stored database and a large language model-based data source. The computer-implemented system further determines the one or more suppliers complying with the user requirement based on a set of supplier data parameters. The set of supplier data parameters includes a tier association, a geographical location, a domain category, a current Environmental, Social, and Governance (ESG) score, a target year, and a priority tag. The computer-implemented system further determines a level of engagement for each of the determined one or more suppliers based on a type of a supplier and the set of supplier data parameters. The level of engagement includes assessments, a target setting and tracking, sustainability initiatives, an employee health and safety, labor practices, and trainings. The computer-implemented system further determines a frequency of engagement for each of the determined one or more suppliers based on the determined level of engagement. The computer-implemented system further obtains a required documentation from each of the determined one or more suppliers in response to sending a notification to complete an engagement process to each of the determined one or more suppliers. The computer-implemented system further verifies the obtained required documentation received from the determined one or more suppliers using Artificial Intelligence (AI) or Large Language Model (LLM) based validations. The computer-implemented system further performs one or more actions corresponding to each of the determined one or more suppliers based on results of verification.

In another aspect, the present disclosure relates to a computer-implemented method for managing a customer-supplier engagement within a sustainability-focused enterprise. The method includes receiving, by a processor, a request for engaging and managing one or more target user or end-user. The request includes user requirements and user preferences. The method further includes determining, by the processor, a source of importing supplier data from among a plurality of data sources based on the user requirement. The plurality of data sources includes one of external database, a locally stored database and a large language model based data source. The method further includes determining, by the processor, the one or more suppliers complying with the user requirement based on a set of supplier data parameters. The set of supplier data parameters includes a tier association, a geographical location, a domain category, a current Environmental, Social, and Governance (ESG) score or Sustainability score, a target year, and a priority tag. The method further includes determining, by the processor, a level of engagement for each of the determined one or more suppliers based on a type of a supplier and the set of supplier data parameters. The level of engagement includes assessments, a target setting and tracking, sustainability initiatives, an employee health and safety, labor practices, and trainings. The method further includes determining, by the processor, a frequency of engagement for each of the determined one or more suppliers based on the determined level of engagement. The method further includes obtaining, by the processor, a required documentation from each of the determined one or more suppliers in response to sending a notification to complete an engagement process to each of the determined one or more suppliers. The method further includes verifying, by the processor, the obtained required documentation received from the determined one or more suppliers using Artificial Intelligence (AI) or Large Language Model (LLM) based validations. The method further includes performing, by the processor, one or more actions corresponding to each of the determined one or more suppliers based on results of verification.

In another aspect, the present disclosure relates to a non-transitory computer readable medium. The non-transitory computer readable medium includes a processor-executable instructions that cause a processor to receive a request for engaging and managing one or more target user or end-user. The request includes user requirements and user preferences. The processor determines a source of importing supplier data from among a plurality of data sources based on the user requirement. The plurality of data sources includes one of external database, a locally stored database and a large language model based data source. The processor further determines the one or more suppliers complying with the user requirement based on a set of supplier data parameters. The set of supplier data parameters includes a tier association, a geographical location, a domain category, a current Environmental, Social, and Governance (ESG) score, a target year, and a priority tag. The processor further determines a level of engagement for each of the determined one or more suppliers based on a type of a supplier and the set of supplier data parameters. The level of engagement includes assessments, a target setting and tracking, sustainability initiatives, an employee health and safety, labor practices, and trainings. The processor further determines a frequency of engagement for each of the determined one or more suppliers based on the determined level of engagement. The processor further obtains a required documentation from each of the determined one or more suppliers in response to sending a notification to complete an engagement process to each of the determined one or more suppliers. The processor further verifies the obtained required documentation received from the determined one or more suppliers using Artificial Intelligence (AI) or Large Language Model (LLM) based validations. The processor further performs one or more actions corresponding to each of the determined one or more suppliers based on results of verification.

To further clarify the advantages and features of the present disclosure, a more particular description of the disclosure may follow by reference to specific embodiments thereof, which are illustrated in the appended figures. It is to be appreciated that these figures depict only typical embodiments of the disclosure and are therefore not to be considered limiting in scope. The disclosure may be described and explained with additional specificity and detail with the appended figures.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It may be appreciated by those skilled in the art that disclosure of such drawings include the disclosure of electrical components, electronic components or circuitry commonly used to implement such components.

FIG. 1 illustrates an exemplary block diagram representation of a computer-implemented system for managing a customer-supplier engagement within a sustainability-focused enterprise, in accordance with embodiments of the present disclosure.

FIG. 2 illustrates an exemplary block diagram representation of a computer-implemented system, such as those shown in FIG. 1, capable of managing the customer-supplier engagement within the sustainability-focused enterprise, in accordance with embodiments of the present disclosure.

FIG. 3 illustrates an exemplary representation of plurality of modules in a sustainability focused architecture, in accordance with embodiments of the present disclosure.

FIG. 4 illustrates an exemplary enterprise platform with the computer implemented system for managing the customer-supplier engagement within the sustainability-focused enterprise, in accordance with embodiments of the present disclosure.

FIG. 5 illustrates an exemplary global heat map of suppliers of the enterprise, in accordance with embodiments of the present disclosure.

FIG. 6 illustrates an exemplary first user interface with supplier's newsletter or Quarterly Business Review (QBR) chart, in accordance with embodiments of the present disclosure.

FIG. 7A illustrates an exemplary second user interface for the customer-supplier engagement, in accordance with embodiments of the present disclosure.

FIG. 7B, illustrates an exemplary third user interface for the supplier engagement, in accordance with the embodiments of the present disclosure.

FIG. 7C illustrates an exemplary fourth user interface for the supplier engagement in accordance with the embodiments of the present disclosure.

FIG. 7D illustrates an exemplary fifth user interface for the supplier engagement, in accordance with the embodiments of the present disclosure.

FIG. 8 illustrates an exemplary process flowchart depicting an exemplary process of the customer-supplier engagement, in accordance with the embodiments of the present disclosure.

FIGS. 9A-9B collectively illustrates an user interface for exemplary customer engagement for an enterprise, in accordance with embodiments of the present disclosure.

FIGS. 10A-10C collectively illustrate an Artificial Intelligence (AI) based assistant user interface for a customer-supplier engagement, in accordance with embodiments of the present disclosure.

FIG. 11 illustrates an exemplary block diagram representation of an exemplary AI assistant copilot framework, in accordance with embodiments of the present disclosure.

FIG. 12 illustrates an exemplary block diagram representation of a plurality of user for the customer-supplier engagement within the sustainability-focused enterprise, in accordance with embodiments of the present disclosure.

FIG. 13 is an exemplary block diagram representation of a hardware platform for implementation of the disclosed system, in accordance with embodiments of the present disclosure.

FIG. 14 is an exemplary flowchart illustrating an example method for managing a customer-supplier engagement within a sustainability-focused enterprise, in accordance with embodiments of the present disclosure.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It may be apparent, however, that embodiments of the present disclosure may be practiced without these specific details. Several features described hereafter may each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments may provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it may be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, and the like. When a process corresponds to a function, its termination may correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes”,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It may be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless otherwise defined, all technical and scientific terms used herein have the same meaning as commonly understood by those skilled in the art to which this disclosure belongs. The system, methods, and examples provided herein are and not intended to be limiting. A computer system (standalone, client, or server, or computer-implemented system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or a “subsystem” may also comprise programmable logic or circuitry (as encompassed within a general-purpose processor or other programmable processor) that is temporarily configured by software to perform certain operations. Accordingly, the term “module” or “subsystem” should be understood to encompass a tangible entity, be that an entity that is physically constructed permanently configured (hardwired), or temporarily configured (programmed) to operate in a certain manner and/or to perform certain operations described herein.

A computer system (standalone, client or server computer system) is configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

The present disclosure provides a computer-implemented system and method for managing a customer-supplier engagement within a sustainability-focused enterprise. The computer-implemented system receives a request for engaging and managing one or more target user or end-user. The request includes user requirements and user preferences. The computer-implemented system further determines a source of importing supplier data from among a plurality of data sources based on the user requirement. The plurality of data sources includes one of external database, a locally stored database and a large language model based data source. The computer-implemented system further determines the one or more suppliers complying with the user requirement based on a set of supplier data parameters. The set of supplier data parameters includes a tier association, a geographical location, a domain category, a current Environmental, Social, and Governance (ESG) score or Sustainability score, a target year, and a priority tag. The computer-implemented system further determines a level of engagement for each of the determined one or more suppliers based on a type of a supplier and the set of supplier data parameters. The level of engagement includes assessments, a target setting and tracking, sustainability initiatives, an employee health and safety, labor practices, and trainings. The computer-implemented system further determines a frequency of engagement for each of the determined one or more suppliers based on the determined level of engagement. The computer-implemented system further obtains a required documentation from each of the determined one or more suppliers in response to sending a notification to complete an engagement process to each of the determined one or more suppliers. The computer-implemented system further verifies the obtained required documentation received from the determined one or more suppliers using Artificial Intelligence (AI) or Large Language Model (LLM) based validations. The computer-implemented system further performs one or more actions corresponding to each of the determined one or more suppliers based on results of verification.

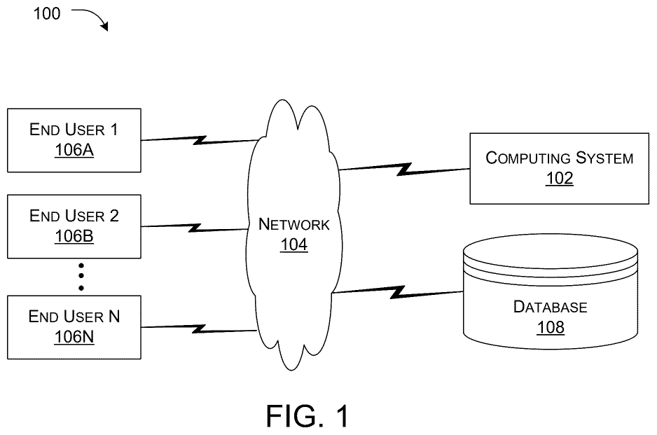

Referring now to the drawings, and more particularly to FIG. 1 through FIG. 14, where similar reference characters denote corresponding features consistently throughout the figures, there are shown preferred embodiments, and these embodiments are described in the context of the following exemplary system and/or method.

FIG. 1 illustrates an exemplary block diagram 100 representation of a computer-implemented system 102 (also herein referred as computing system 102) for managing a customer-supplier engagement within a sustainability-focused enterprise, in accordance with embodiments of the present disclosure. The block diagram 100 may include the computer-implemented system 102, a network 104, one or more end-users 106A, 106B, . . . , and 106N (individually referred to as an end-user 106, and collectively referred to as the end users 106) (also herein referred as supplier 106 or suppliers 106) and an external database 108. In an embodiment, the computer-implemented system 102 may be, for example, but not limited to, a server system. Some examples of the server systems may be, but are not limited to, a cloud server, a centralized server, a rack server, a network server, a computer-based server, on premise server, a dedicated server, a remote server, an edge server and the like. The network 104 may be a wired communication network and/or a wireless communication network. For example, the sustainability-focused enterprise may be one where GreenHouse Gases (GHG) emissions such as scopes 1, 2, and 3, water, and waste tracking management may be performed in regular basis to control a carbon foot print between the enterprise and the end-users 106.

In a non-limiting example, the one or more end-users 106A, 106B, . . . , and 106N may include for example, but not limited to, manufactures of electronics, vehicles, electric vehicles, software, and the like.

Further, the computer-implemented system 102 may include, but is not limited to, a mobile device, a smartphone, a Personal Digital Assistant (PDA), a tablet computer, a phablet computer, a wearable computing device, a Virtual Reality/Augmented Reality (VR/AR) device, a laptop, a desktop, a server, and the like.

Furthermore, the computer-implemented system 102 may be implemented by way of a single device or a combination of multiple devices that may be operatively connected or networked together. The computer-implemented system 102 may be implemented in hardware or a suitable combination of hardware and software. The computer-implemented system 102 may be a hardware device including a processor executing machine-readable program instructions. Execution of the machine-readable program instructions by the processor may enable the computer-implemented system 102 to for managing a customer-supplier engagement within a sustainability-focused enterprise. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more processors may include, for example, microprocessors, microcomputers, microcontrollers, digital signal processors, central processing units, state machines, logic circuits, and/or any devices that manipulate data or signals based on operational instructions. Among other capabilities, the processor may fetch and execute computer-readable instructions in the memory operationally coupled with the computer-implemented system 102 for performing tasks such as data processing, input/output processing, and/or any other functions. Any reference to a task in the present disclosure may refer to an operation being or that may be performed on data.

In an embodiment, the end-users 106 may be connected to the computer-implemented system 102 through the network 104, such as for example, but not limited to, the wired communication network and/or the wireless communication network.

The one or more suppliers 106A, 106B, . . . , and 106N may be user devices, including for example, a laptop computer, desktop computer, tablet computer, smartphone and the like. The one or more suppliers 106A, 106B, . . . , and 106N may access web applications via a local web browser.

As an example, a user of user device may access a particular web application by launching a web browser, such as local web browser. The web application may be a normal website, such as the supplier engagement portal, that includes extra metadata that is installed as part of the browser application. Installable web apps may use standard web technologies for server-side and client-side code. Examples of web applications may include, but not limited to, Software As A Service (SAAS), Platform As A Service (PAAS), Cloud based apps, native apps, customer engagement management applications, that run inside the browser. In an embodiment, the web applications (not shown) may be deployed on the computer-implemented system 102 or on any external enterprise data center.

The computer-implemented system 102 may be a cloud computer-implemented system including a cloud interface, cloud hardware and OS, a cloud computing platform, and a database. The cloud interface enables communication between the cloud computing platform and the user device. Also, the cloud interface enables communication between the cloud computing platform and the web application. The cloud hardware and Operating System (OS) may include one or more servers on which an operating system is installed and including one or more processing units, one or more storage devices for storing data, and other peripherals required for providing cloud computing functionality. The cloud computing platform is a platform which implements functionalities such as data storage, data analysis, data processing, data communication on the cloud hardware and Operating System (OS) via APIs and algorithms and delivers the aforementioned cloud services. The cloud computing platform may include a combination of dedicated hardware and software built on top of the cloud hardware and OS. As used herein, “cloud computing environment” refers to a processing environment comprising configurable computing physical and logical assets, for example, networks, servers, storage, applications, services, etc., and data distributed over the cloud platform. The cloud computing environment provides on-demand network access to a shared pool of the configurable computing physical and logical assets. The server may include one or more servers on which the Operating System (OS) is installed. The servers may comprise one or more processors, one or more storage devices, such as, memory units, for storing data and machine-readable instructions for example, applications and Application Programming Interfaces (APIs), and other peripherals required for providing cloud computing functionality.

Though few components and subsystems are disclosed in FIG. 1, there may be additional components and subsystems which is not shown, such as, but not limited to, ports, network devices, databases, network attached storage devices, assets, machinery, instruments, facility equipment, emergency management devices, image capturing devices, cooling devices, heating devices, compressors, any other devices, and combination thereof. The person skilled in the art should not be limiting the components/subsystems shown in FIG. 1.

Those of ordinary skilled in the art may appreciate that the hardware depicted in FIG. 1 may vary for particular implementations. For example, other peripheral devices such as an optical disk drive and the like, Local Area Network (LAN), Wide Area Network (WAN), wireless (e.g., wireless-fidelity (Wi-Fi)) adapter, Bluetooth adapter, graphics adapter, disk controller, Input/Output (I/O) adapter also may be used in addition or place of the hardware depicted. The depicted example is provided for explanation only and is not meant to imply architectural limitations concerning the present disclosure.

Those skilled in the art may recognize that, for simplicity and clarity, the full structure and operation of all data processing systems suitable for use with the present disclosure are not being depicted or described herein. Instead, only so much of the computer-implemented system 102 as is unique to the present disclosure or necessary for an understanding of the present disclosure is depicted and described. The remainder of the construction and operation of the computer-implemented system 102 may conform to any of the various current implementations and practices that were known in the art.

In an exemplary embodiment, the computer-implemented system 102 receives a request for engaging and managing one or more target user or end-user. The one or more target user or end-user may include customers, suppliers, and the like. The request includes user requirements and user preferences. In a non-limiting example, the user requirements and the user preference may be an information requested by an enterprise. The information may be related to a particular supplier and a carbon footprint or sustainability metrics related to the particular supplier. The information may be related to supplier's legal name, registration number, and primary business address and the like, and contact details, including for example, but not limited to, email and phone number of the supplier's representative.

The computer-implemented system 102 further determines a source of importing supplier data from among a plurality of data sources based on the user requirement. The plurality of data sources includes one of external database, a locally stored database, and a large language model-based data source. The computer-implemented system 102 may pull supplier data from diverse sources, including external databases, local storage, and even large language models (LLMs). This flexibility allows for comprehensive data collection. LLMs may be employed to extract relevant information from unstructured text data within external databases or even generate synthetic data to augment existing datasets.

The computer-implemented system 102 determines the one or more suppliers complying with the user requirement based on a set of supplier data parameters. The set of supplier data parameters includes a tier association, a geographical location, a domain category, a current Environmental, Social, and Governance (ESG) score or sustainability score, a target year, and a priority tag. In some embodiments, machine learning algorithms may be used to create predictive models that forecast supplier performance based on historical data and identify potential risks. The computer-implemented system 102 further determines a level of engagement for each of the determined one or more suppliers based on a type of an end-user 106 and the set of supplier data parameters. The level of engagement includes assessments, a target setting and tracking, sustainability initiatives, an employee health and safety, labor practices, and trainings. Natural language processing (NLP) may be used to analyze supplier-provided information (e.g., sustainability reports) to categorize them accurately.

In an exemplary embodiment, the computer-implemented system 102 further determines a frequency of engagement for each of the determined one or more suppliers based on the determined level of engagement. The computer-implemented system 102 further obtains a required documentation from each of the determined one or more suppliers in response to sending a notification to complete an engagement process to each of the determined one or more suppliers. The computer-implemented system 102 further verifies the obtained required documentation received from the determined one or more suppliers using Artificial Intelligence (AI) or Large Language Model (LLM) or block chain-based validations. The computer-implemented system 102 may utilize AI or LLMs to examine submitted documents for authenticity, completeness, and compliance with specified standards. Computer vision may be applied to analyze document images for potential forgery or tampering, while NLP may verify the content against predefined criteria. In some embodiments, blockchain based validations may create a tamper-proof record of document creation, modification, and sharing. The blockchain based validations ensures the integrity and authenticity of documents throughout their lifecycle. The computer-implemented system 102 may track the document's journey from the supplier 106 to the computer-implemented system 102, providing transparency and accountability. The computer-implemented system 102 may automate verification processes based on predefined conditions and rules. The computer-implemented system 102 may enforce compliance with contractual obligations and document requirements. In some embodiments, AI may initially screen documents for basic anomalies. LLM may analyze the content for consistency and compliance. Blockchain may provide an immutable record of the document and its verification status. By leveraging these technologies together, the computer-implemented system 102 may significantly enhance the accuracy and reliability of document verification.

The computer-implemented system 102 further performs one or more actions corresponding to each of the determined one or more suppliers based on results of verification. In one example, some machine learning models may be trained on vast datasets of authentic and fraudulent documents to identify patterns and anomalies. The ML models may detect inconsistencies, forgeries, or manipulated data within supplier documents. Further, the ML models may assess the completeness and accuracy of information provided.

In some example embodiments, Convolutional Neural Networks (CNNs) may be used for image-based verification. For example, the CNNs may be used to detect forgeries, watermarks, or specific elements in a document image. The computer-implemented system 102 may preprocess image of the documentation received from the plurality of suppliers by converting them to grayscale, resize, and normalize the documents. The computer-implemented system 102 creates a CNN architecture with convolutional layers to extract features. Further, the computer-implemented system 102 may add pooling layers to reduce dimensionality and use fully connected layers for classification (e.g., genuine vs. forged). For example, detecting forged signatures by training a CNN on a dataset of genuine and forged signature images.

In some alternate embodiments, recurrent Neural Networks (RNNs) and Long Short-Term Memory (LSTM) networks may be used for text-based verification. The computer-implemented system 102 may verify document content consistency, detect anomalies, or extract key information. The computer-implemented system 102 may preprocess text by using for example, tokenization, stemming, and stop word removal. The computer-implemented system 102 may create an RNN or LSTM model to process sequential text data. Further, the computer-implemented system 102 may train the model on a dataset of genuine documents to learn language patterns. The computer-implemented system 102 may use the trained model to analyze new documents for anomalies or inconsistencies. The computer-implemented system 102 may further detect fraudulent insurance claims by analyzing claim narratives for inconsistencies and red flags.

In yet another embodiment, the computer-implemented system 102 may use transformer-based text and image verification methods. The computer-implemented system 102 understands complex relationships between text and image content. In order to achieve this, the computer-implemented system 102 may preprocess text and image data and use a transformer model to process both modalities simultaneously. The computer-implemented system 102 may train the model on a dataset with paired text and image data. The computer-implemented system 102 may use the trained model to verify the consistency between text and image content. For example, verifying the authenticity of product images by comparing product descriptions with corresponding images.

In some embodiment, the machine learning based models may be used to identify anomalies or patterns in document data, extract relevant features from document data and choose a suitable machine learning algorithm (e.g., decision trees, random forests, support vector machines and the like). Further, the computer-implemented system 102 may train the model on a labeled dataset of normal and anomalous data and use the trained model to detect anomalies in new documents. For example, detecting fraudulent loan applications by identifying unusual patterns in applicant data. Such systems may ensure high-quality, labeled data as it is essential for training accurate models. Further, the computer-implemented system 102 continuously evaluates model performance using appropriate metrics and combines multiple models that may improve overall performance. The computer-implemented system 102 may further use explainable AI to understand how models make decisions to build trust.

In an exemplary embodiment, the computer-implemented system 102 generates an Agentic AI framework using large language models (LLMs). These large language models (LLMs) are typically pre-trained on massive text corpora using unsupervised learning techniques which may be further explained in detail. The Agentic AI framework may support the processing of Audio, Video and various types of documents such as for example, PDF®/ WORD®/Excel®/XML®/JSON® and the like such that it may help to autofill the assessments for both suppliers and customers.

The Agentic AI framework involves various components as outlined below. For example, a web crawler may be used to crawl the web to capture various types of public information based on certain key words as well as the customer specific field of business. Further, chunking may be used to split the data or content into chunks for easier processing. The computer-implemented system 102 may use Llama index for this purpose. Further, the computer-implemented system 102 may use vector database to store all the information generated after chunking. Furthermore, the computer-implemented system 102 may use LLMs to improve the accuracy and relevance of the responses. The computer-implemented system 102 may further use question extractor to extract the meta data and format each question from the assessment. An answer generator may be further used to format the identified answer to an understandable format to the backend services. A retriever may be used to index RAG and to capture all the related information that may be used to identify the most accurate answer for a given question A preprocessor such as a Llama parser is used to preprocess the documents making them available for chunking. As part of this component, Audio files, Images and Video files may be converted to text. The computer-implemented system 102 may further use a fact checker using index RAG to check that the response identified is part of information captured and available to the system. A feedback processor may be used to share feedback with the computer-implemented system 102 regarding the accuracy of the response identified. This may help to improve the accuracy of the Retriever and Answer generator.

In an exemplary embodiment, the computer-implemented system 102 obtains the required documentation from each of the determined one or more supplier's trough the processor. The processor is configured to obtain a supply chain data associated with the determined one or more suppliers. In an embodiment, the supply chain data may refer to the information collected and processed throughout the various stages of the supply chain, from raw material procurement to the delivery of finished products to customers. The supply chain data may help businesses to manage and optimize the flow of goods, services, and information. The processor is configured determine a product-level emission factor associated with the determined one or more suppliers by assessing the obtained supply chain data. In an embodiment, the product-level emission may refer to the GreenHouse gas (GHG) emissions associated with the production, use, and disposal of a specific product throughout its lifecycle. These emissions may be typically measured in terms of carbon dioxide (CO₂) equivalents (CO₂e) to account for the various gases that contribute to climate change. The one or more actions includes tracking emissions data such as Carbon Di-Oxide (CO2) emissions for example, but not limited to, from fossil fuels, transportation emissions, production emissions, and landfill emissions. Further, the one or more actions assessing product life cycle such as for example, but not limited to, raw material extraction, manufacturing distribution, maintenance, and disposal. Furthermore, the one or more actions may include assessing materiality such as for example, but not limited to, financial reporting materiality, environmental materiality, and supply chain materiality. Subsequently, the one or more actions may also include sharing assessments and reports with suppliers such as for example, but not limited to, supplier sustainability assessment, supplier quality assessment, and supplier compliance and regulatory report. Furthermore, the one or more actions may include tracking product-level emissions factors such as for example, but not limited to, a smartphone, an electric vehicle, and a glass bottle.

In an exemplary embodiment, the computer-implemented system 102 may provide a user-friendly interface for enterprises to maintain all their supplier data in one place by providing multiple options, thus facilitating to onboard suppliers and collect data. The computer-implemented system 102 may onboard the suppliers by connecting to customers supplier management system (auto) or create them through the User Interface (UI) (manual) or import the data from a file like csv/excel and the like. The computer-implemented system 102 may integrate with popular Enterprise Resource Planning (ERP) systems such as Systems, Applications and Products (SAP), Oracle, and Microsoft Customer Relationship Management (CRM). The computer-implemented system 102 allows for easy extraction and analysis of supplier data. While using the import process, customers may also define what details of supplier they want to import and the like.

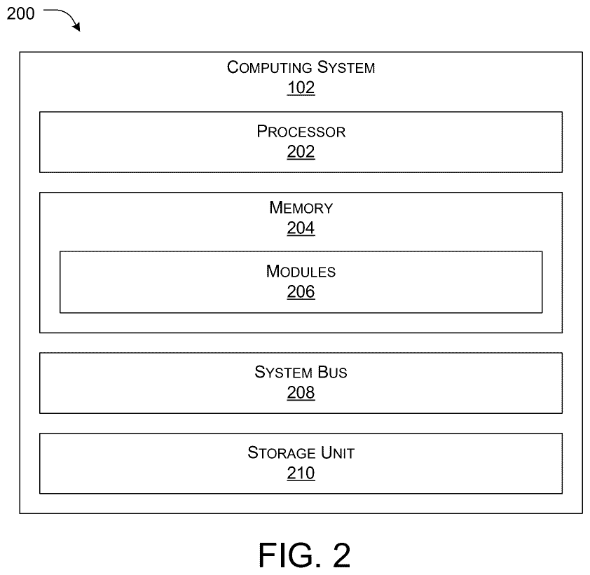

FIG. 2 illustrates an exemplary block diagram representation 200 of a computer-implemented system 102, such as those shown in FIG. 1, capable of managing the customer-supplier engagement within the sustainability-focused enterprise, in accordance with embodiments of the present disclosure, in accordance with embodiments of the present disclosure. The computer-implemented system 102 may include the one or more processors 202, the memory 204, and a storage unit 210. The one or more processors 202 (also individually referred as a processor 202), the memory 204, and the storage unit 210 are communicatively coupled through a system bus 208 or any similar mechanism. The memory 204 includes the plurality of modules 206 in the form of programmable instructions executable by the one or more processors 202.

The one or more processors 202, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more processors 202 may also include embedded controllers, such as generic or programmable logic devices or arrays, application-specific integrated circuits, single-chip computers, and the like.

The memory 204 may be a non-transitory volatile memory and a non-volatile memory. The memory 204 may be coupled to communicate with the one or more hardware processors 202, such as being a computer-readable storage medium. The one or more hardware processors 202 may execute machine-readable instructions and/or source code stored in the memory 204. A variety of machine-readable instructions may be stored in and accessed from the memory 204. The memory 204 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory 204 may include the plurality of modules 206 stored in the form of machine-readable instructions on any of the above-mentioned storage media and may be in communication with and executed by the one or more processors 202.

The storage unit 210 may be a cloud storage or a database such as those shown in FIG. 1. The storage unit 210 may be any kind of database such as, but are not limited to, relational databases, dedicated databases, dynamic databases, monetized databases, scalable databases, cloud databases, distributed databases, any other databases, and a combination thereof.

In an exemplary embodiment, further to track and calculate the emissions data, the processor 202 is configured to determine corresponding emission value of the supplier 106 by analyzing at least one of a water usage, a waste generation, stationary combustion sources, and purchased gases. The one or more actions includes extracting one or more supplier inputs for inclusion in sustainability assessments based on the obtained required documentation. The one or more actions further includes interpreting the extracted one or more supplier inputs and generate automated responses to the extracted one or more supplier inputs by deploying one or more AI agents. The extracted one or more supplier inputs are interpreted by the one or more AI agents using one of a natural language processing model and a natural language understanding model.

In an exemplary embodiment, the supplier device includes the processor 202. The processor 202 is configured to receive a notification to complete the engagement process. The notification includes a set of questionnaire related to the supplier. The processor is configured determine an information required for responding to the set of questionnaire related to the supplier by parsing the received notification using large language models such as for example, but not limited to, XLNet, and GShard. The processor 202 is configured automate responses to the set of questionnaire based on the determined information using an artificial intelligence assisted system. The processor 202 is configured send the auto-populated responses as the required documentation to the user.

In an exemplary embodiment, the one or more actions includes generating and displaying one or more visual representations representing geographical distribution and concentration of the plurality of suppliers. In an embodiment, the geographical distribution of suppliers may refer to the spatial arrangement or location of suppliers across different regions, countries, or continents that a business engages with to source raw materials, products, or services. Further, in an embodiment, the concentration of suppliers may refer to the degree to which a company relies on a small number of suppliers for its goods and services, as opposed to spreading its sourcing across a larger and more diverse set of suppliers. The one or more actions includes generating a location-based risk score associated with each of the plurality of suppliers based on the generated global heat map. The one or more actions includes tuning the level of engagement for each of the determined one or more suppliers based on the generated location-based risk score. This may refer to the process of adjusting the intensity, type, or nature of the relationship or interaction a company has with its suppliers based on a risk assessment that is influenced by the suppliers'geographic locations. The one or more actions includes customizing the level of engagement with the plurality of suppliers based on a type of the supplier. The one or more actions further includes validating whether the plurality of suppliers comply with at least one of ESG regulations and enterprise regulations by evaluating performance of each of the plurality of suppliers. This may refer to a process by which a company assesses and ensures that its suppliers are meeting relevant standards and regulations related to Environmental, Social, and Governance (ESG) factors, as well as the company's own internal (enterprise) regulations. The supplier performance metrics may include n-time delivery rates or average lead times for goods or services, defect rates indicating percentage of goods or services that fail to meet quality standards, response times, how quickly the supplier addresses queries, complaints, or service requests or the like.

In an embodiment, the processor 202 may tune the level of engagement for each of the determined one or more end-users 106 based on the generated location-based risk score.

The one or more actions further includes customizing the level of engagement with the plurality of suppliers based on results of validation. This may refer to the process of adjusting how a company interacts with and manages its suppliers based on the outcomes of an evaluation or validation process. This evaluation typically involves assessing whether suppliers meet certain standards, such as compliance with regulations (e.g., ESG, enterprise regulations) or performance criteria (e.g., quality, delivery, cost).

In an exemplary embodiment, the one or more actions includes receiving an Environmental, Social, and Governance (ESG) data or sustainability-related data from the plurality of suppliers. The ESG data may include current ESG score or sustainability metrics, carbon footprint or emissions data of the supplier's operations, information on the supplier's use of renewable energy or recycling practices and social metrics such as employee welfare programs or diversity initiatives. The one or more actions further includes generate at least one of an AI-powered predictions, recommendations, and scenario-based insights on the received ESG or sustainability data such as for example, but not limited to, AI-powered Predictions on ESG Data, AI-powered Scenario-based Insights for Risk Management, and AI-powered Scenario-based Insights for Social Impact. The one or more actions further includes defining sustainability goals and decarbonization targets for each of the plurality of suppliers such as for example, but not limited to, carbon emissions reduction targets for suppliers, waste management goals for suppliers, and water usage reduction goals for suppliers, using the generated at least one AI-powered predictions, and the recommendations. The one or more actions further includes assessing Key Performance Indicators (KPIs) for each of the plurality of suppliers based on the defined and sustainability goals and decarbonization targets.

In an embodiment, the memory 204 may comprise processor-executable instructions, in which the memory 204 may cause the processor 202 to receive a request for engaging and managing one or more target user or end-user, in which the request may comprise user requirements and user preferences. Further, the processor 202 may determine a source of importing end-user data from among a plurality of data sources based on the user requirements, in which the plurality of data sources comprise one at least one of, for example, but not limited to, external database, a locally stored database and a large language model based data source. Further, the processor 202 may determine the one or more end-users 106 complying with the user requirements based on a set of end-user data parameters, in which the set of end-user data parameters may comprise at least one of, for example, but not limited to, a tier association, a geographical location, a domain category, a current Environmental, Social, and Governance (ESG) score or sustainability score, a target year, and a priority tag.

In an embodiment, the processor 202 may determine a level of engagement for each of the determined one or more end-users 106 based on a type of an end-user and the set of end-user data parameters, in which the level of engagement may comprise at least one of for example, but not limited to, assessments, a target setting and tracking, sustainability initiatives, an employee health and safety, labor practices, and trainings. Furthermore, the processor 202 may determine a frequency of engagement for each of the determined one or more end-users 106 based on the determined level of engagement, and obtain a required documentation from each of the determined one or more end-users 106 in response to sending a notification to complete an engagement process to each of the determined one or more end-users.

In an embodiment, the processor 202 may verify the obtained required documentation received from the determined one or more end-users 106 using Artificial Intelligence (AI) or Large Language Model (LLM) based validations, and perform one or more actions corresponding to each of the determined one or more end-users 106 based on results of verification.

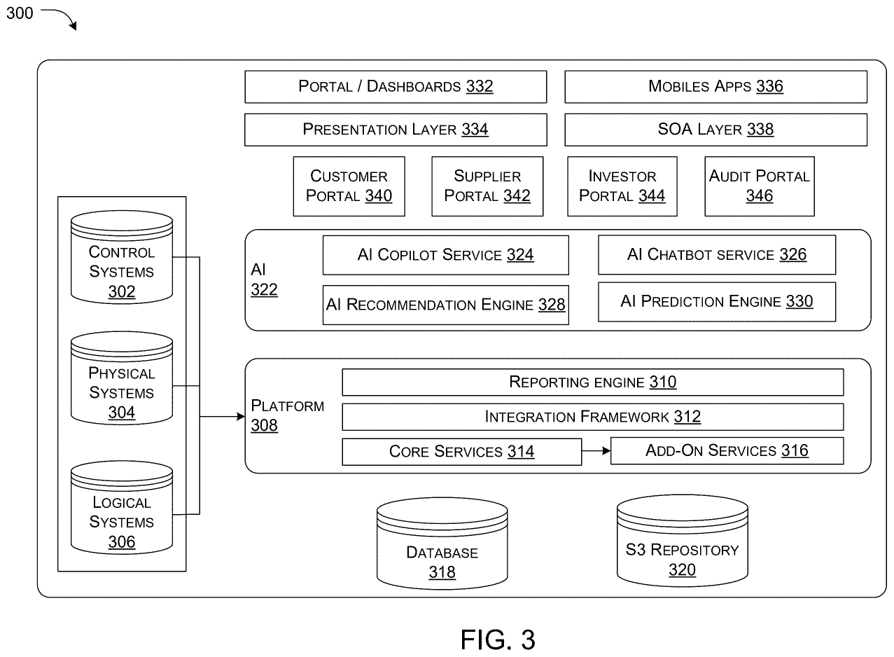

FIG. 3 illustrates an exemplary representation of plurality of modules 206 in the sustainability focused architecture 300, in accordance with embodiments of the present disclosure. The plurality of modules 206 includes an Artificial Intelligence (AI) module 322 (also herein referred as Large Language Model (LLM) module 322). The AI module 322 includes an AI copilot service 324, an AI recommendation engine 328, an AI chatbot service 326, and an AI prediction engine 330. The AI or module 322 receives one or more inputs from a control systems 302, a physical systems 304, a logical systems 306, a database 318, and a S3 repository 320. Further, the AI module 322 extracts data from a core service platform 314 (also referred as core services 314), add-on services 316, an integration framework 312, and reporting engine 310 of a platform 308 (as shown in FIG. 3).

Further in an embodiment, the plurality of modules 206 comprises a portal/dashboard 332, mobile apps 336, a customer portal 340, a supplier portal 342, an investor portal 344, and an audit portal 346.

In an exemplary embodiment, the AI copilot service 324 helps customers and the end-users 106 to automate the process of responding to assessments. The AI copilot service 324 is used by the computer-implemented system 102 to create the copilot frame-work. The AI copilot service 324 may auto fill the requested information by analyzing the data available in the S3 repository 320, the database 318 and the like that is pertaining to the specific customer or the end-user 106.

In an exemplary embodiment, the AI copilot service 324 further provides service that uses an industry leading data framework for building LLM applications to parse the documents and save the data object. Then the computer-implemented system 102 may be used to obtain relevant information from the data object stored, which may be then sent to Generative Pre-training Transformer (GPT) such as for example, but not limited to, a ChatGPT, to obtain actual answers.

In an exemplary embodiment, the AI recommendation engine 328 is based on the ESG or sustainability data collected, an AI-powered predictions, the recommendations, and what-if analysis. The enterprise may set goals, decarbonization targets, and use embedded project management functionality to plan and execute strategies to achieve the enterprise KPIs.

In an exemplary embodiment, the AI chatbot service 326 helps customers or the end-users 106 with any ESG or sustainability related questions. Further the AI prediction engine 330 generates predictions, recommendations, and scenario based insights on the received ESG or sustainability data such as for example, but not limited to, the AI-powered Predictions on ESG Data, the AI-powered Scenario-based Insights for Risk Management, and the AI-powered Scenario-based Insights for Social Impact. The computer-implemented system 102 is accessed through a presentation layer 334 and Service Oriented Architecture (SOA) layer 338 of the plurality of modules 206.

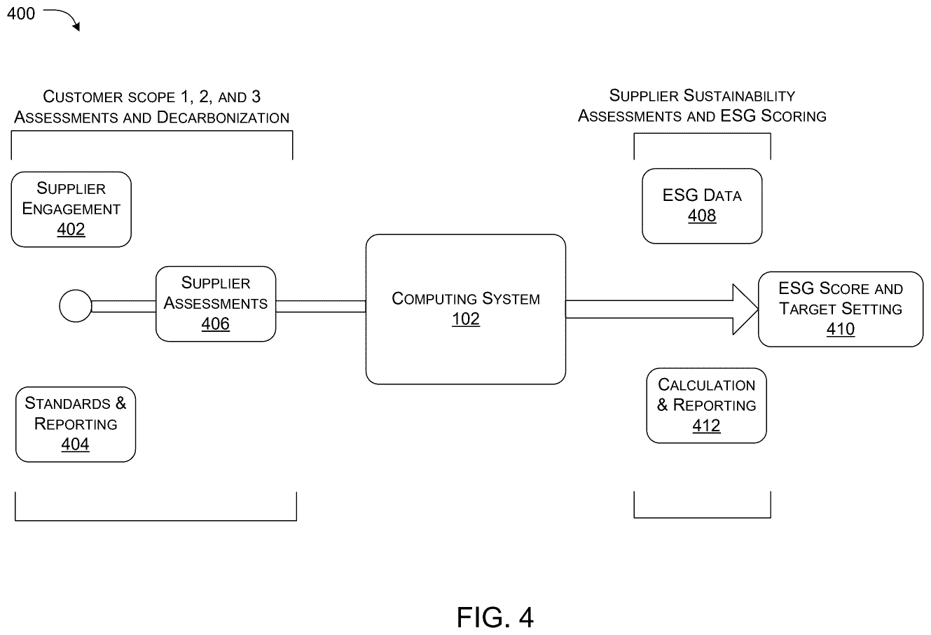

FIG. 4 illustrates an exemplary enterprise platform 400 with the computer implemented computer-implemented system 102 for managing the customer-supplier engagement within the sustainability-focused enterprise, in accordance with embodiments of the present disclosure. The enterprise platform 400 is designed to address most common challenges of supply chain sustainability, such as Scope 3 emissions data tracking and calculations, product Life Cycle Assessments (LCA), materiality assessments, and the like. The computer-implemented system 102 provides a supplier sustainability portal which brings all suppliers into the software, helping customers more easily manage the supplier engagement 402 process and collecting data from their supply chain. The computer-implemented system 102 may be used to share supplier assessments 406 and reports with suppliers and may additionally help customers track product-level emissions factors. Through the computer-implemented system 102, suppliers are empowered by AI Services or AI Agents and data integrations to collect data across multiple sources and formats. Inbuilt calculators and conversions tools, based on industry standard GHG guidelines, simplify carbon emissions accounting or sustainability metrics for suppliers and customers. The computer-implemented system 102 may offer configurable reporting tools aligned with multiple reporting frameworks to enable suppliers to report on emissions and other ESG data 408 or sustainability data.

In an embodiment, the enterprise platform comprises a standards and reporting 404, a ESG score and target setting 410, and a calculation and reporting 412.

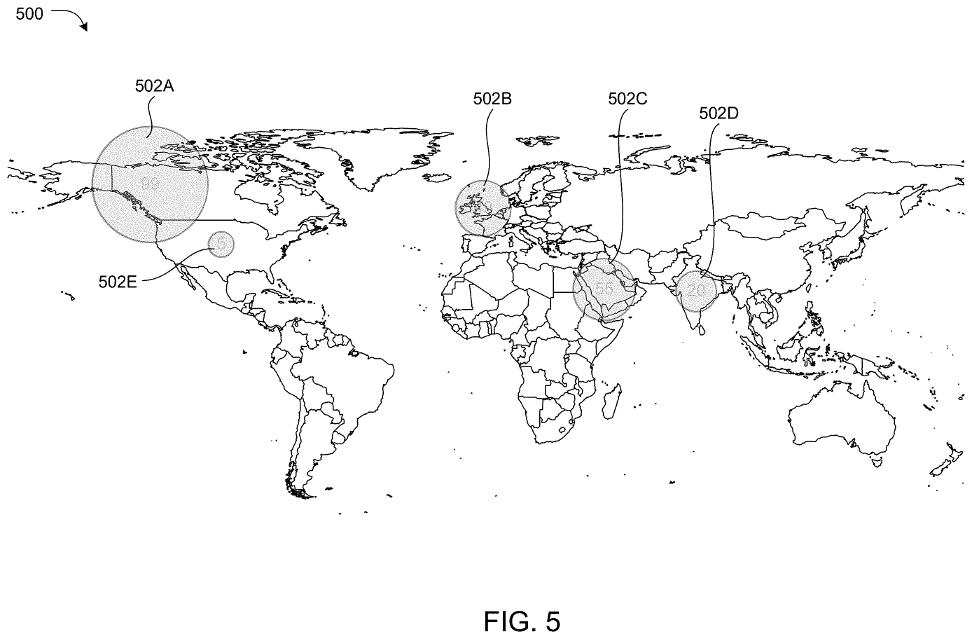

FIG. 5 illustrates a exemplary global heat map 500 of the end-users 106, in accordance with embodiments of the present disclosure. The global heat map helps the customer to understand worldwide presence of the end-users 106. The map may help to understand a geographical concentration of the end-users 106 and helps to better understand the location-based risks such as for example, but not limited to, natural disaster, geopolitical instability, trade barriers, and supply chain vulnerabilities due to climate change, and the like. For example, as shown in FIG. 5, at location 1 502A, the concentration of the end-users 106 is 99, at location 2 502B, the concentration of the end-users 106 is 49, at location 3 502C, the concentration of the end-users 106 is 55, and at location 4 502D, the concentration of the end-users 106 is 20. Similarly, at location 5 502E, the concentration of the end-users 106 is 5. In this way, the global heat map 500 may help to understand a geographical concentration of the end-users 106.

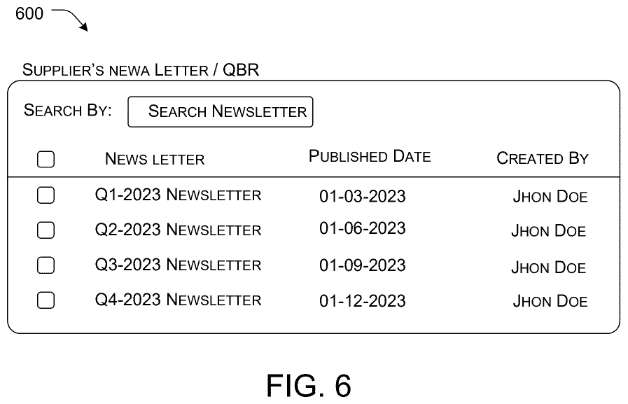

FIG. 6 illustrates an exemplary first user interface 600 with newsletter/QBR chart of the end-users 106, in accordance with embodiments of the present disclosure. In an embodiment, the newsletter/QBR chart of the end-users 106 may summarize the timeline related to various new letters/QBR charts that are published/shared with all the end-users 106.

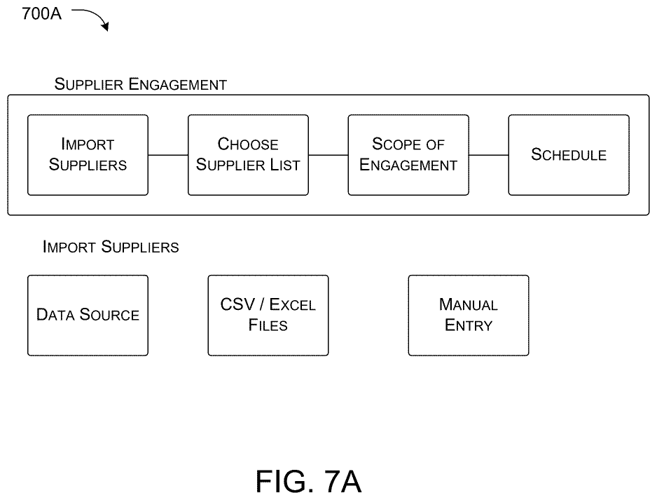

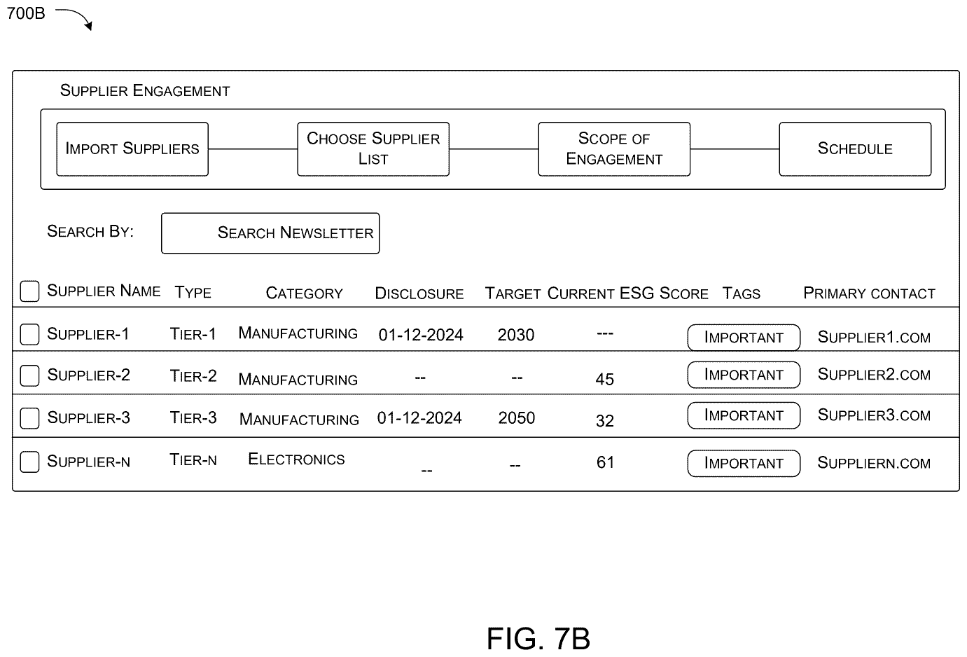

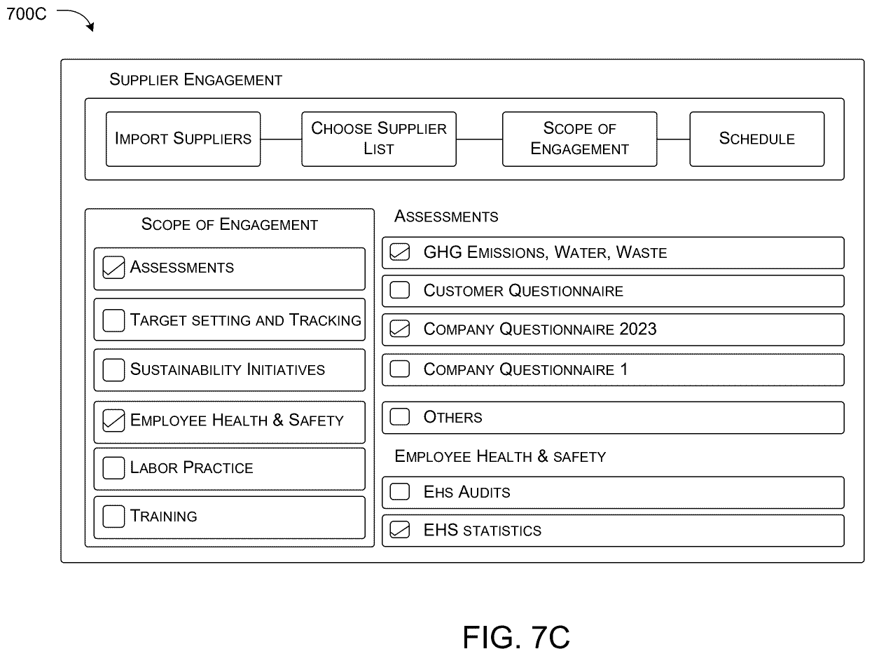

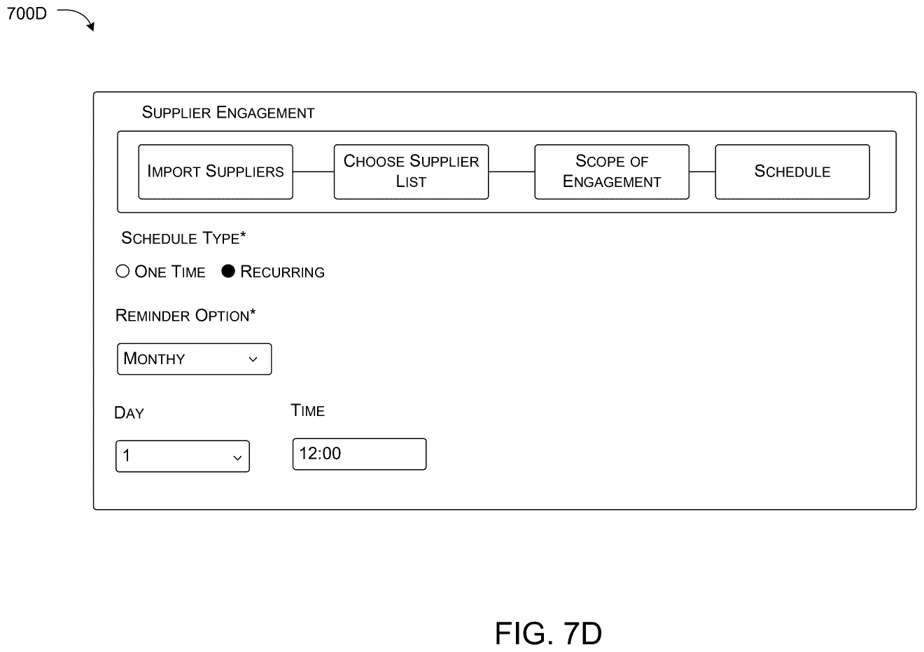

FIG. 7A illustrates an exemplary second user interface 700A for the customer-supplier engagement, in accordance with embodiments of the present disclosure. The multi-step process includes customers, in which the customers may be given a choice to define the applicability of the engagement. The customer may decide how the data of the end-users 106 may be entered into the computer-implemented system 102. The engagement may be achieved by pulling the supplier details in one of either Auto or Manual or Import process.

FIG. 7B illustrates an exemplary third user interface 700B for the supplier engagement, in accordance with the embodiments of the present disclosure. The computer-implemented system 102 decides the end-users 106 involved in the Artificial Intelligence (AI) or Life Cycle Monitoring (LCM) module. The computer-implemented system 102 may enable the customer to choose the list of end-users 106, involved in the engagement model. The computer-implemented system 102 provides flexibility to the customers to filter the end-users 106 by different parameters, based on Tier association or category of the end-users 106 (also referred as the suppliers 106).

FIG. 7C illustrates an exemplary fourth user interface 700C for the supplier engagement, in accordance with the embodiments of the present disclosure. The computer-implemented system 102 allows the customer to decide the level of engagement such as assessments or initiatives or labor practices or trainings or Environment, Health and Safety (EHS) or target setting, and the like. Once the level of engagement is defined, the next step involves defining the frequency of the engagement.

FIG. 7D illustrates an exemplary fifth user interface 700D for the supplier engagement, in accordance with the embodiments of the present disclosure. In an engagement model, customers may define the frequency of the engagement. The engagement may be an ad hoc one timer or a periodic one such as a monthly or quarterly or yearly and the like. Further, the computer-implemented system 102 may provide flexibility to the customers to minimize the manual efforts and automate the whole process completely. Further individual notifications may be delivered to each supplier 106 involved providing all the necessary details needed to complete the engagement. Periodic reminder or escalation notifications may also be delivered to the suppliers 106 in case progress is not observed. The computer-implemented system 102 may provide control to the customer to define the frequency of the notifications, and delivery of notifications to the suppliers 106. Also the customers may review the responses received from the suppliers 106 and take an action such as for example, but not limited to, approving or rejecting the information.

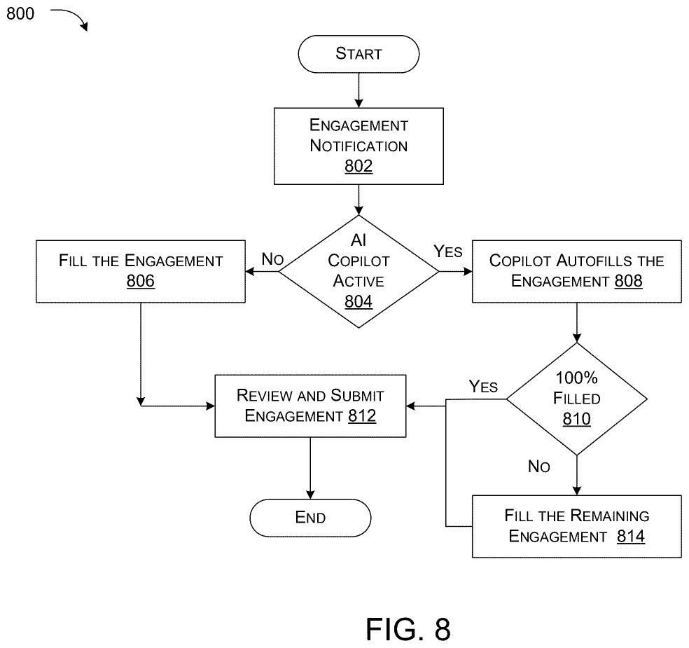

FIG. 8 illustrates an exemplary process flowchart 800 depicting an exemplary process of customer-supplier engagement, in accordance with the embodiments of the present disclosure.

At step 802, the supplier engagement process is initiated by the customer requesting information from their suppliers 106 engaged in an business.

At step 804, the computer-implemented system 102 sends an engagement notification to the enterprise. The supplier 106 involved in the engagement may receive a notification after the notification has been triggered by the customer. The notification may have all the necessary details such as for example, but not limited to, expectations from the supplier 106, timelines to complete the engagement and the like. Further, there may be a separate card for each level of engagement.

At step 804, the computer-implemented system 102 (also hereby referred to as AI agent) checks whether the AI copilot is active or not. If the copilot is not active, as shown in step 806, then an engagement form is filled by for example, but not limited to, the supplier and the customer. On the other hand, if the AI copilot is active, as shown in step 808, then the AI copilot may auto-fill the engagement form. Thereupon the engagement form may be 100% filled, as shown in step 810.

At step 812, the computer-implemented system 102 reviews and submits the engagement form. Each level of engagement may be worked upon individually on the suppliers 106, and progress work may be saved to for later execution. One approach to work on the engagement is for supplier 106 to fill up the requested information manually by collecting the information needed using the review button. The supplier 106 may provide the remaining details not filled in by the AI Copilot as well as review the responses provided by the AI Copilot, as shown in step 814. Once completed, the supplier 106 may submit the engagement to bring it to the closure.

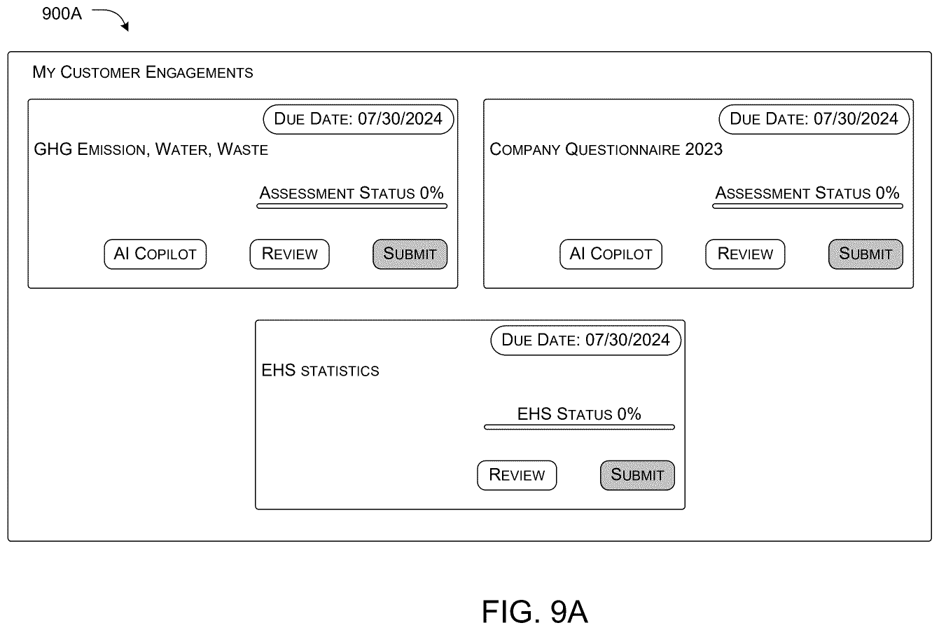

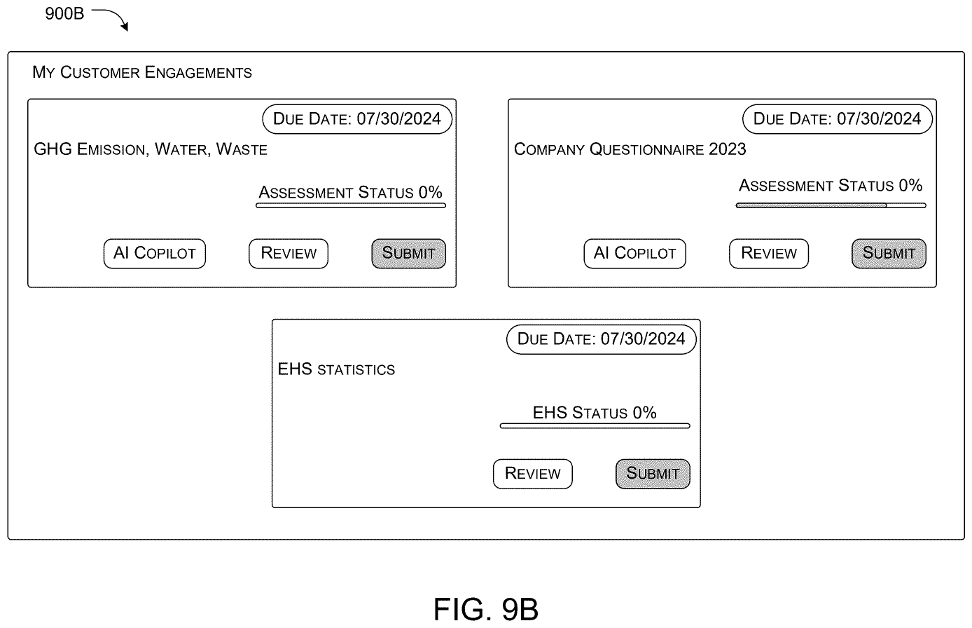

FIGS. 9A-9B collectively illustrates an exemplary user interface 900A and 900B for the customer engagement, in accordance with embodiments of the present disclosure. A measurement or calculator engine such as for example, but not limited to, carbon footprint calculator engine, and a risk assessment engine, following the industry standard GHG protocol may be used by the computer-implemented system 102 for calculating the emissions data from various categories of information like water or waste or stationary combustion or purchased gases and the like.

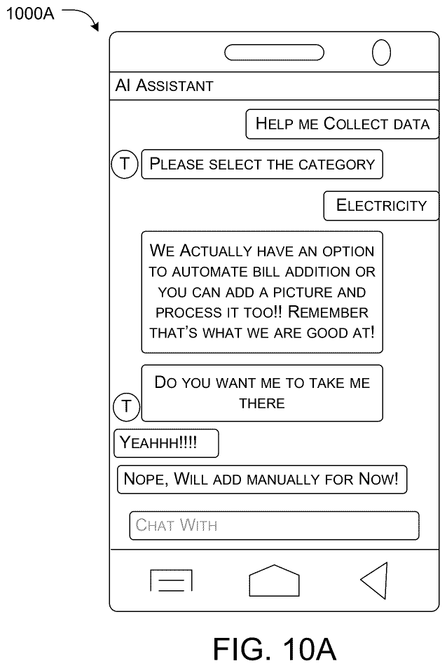

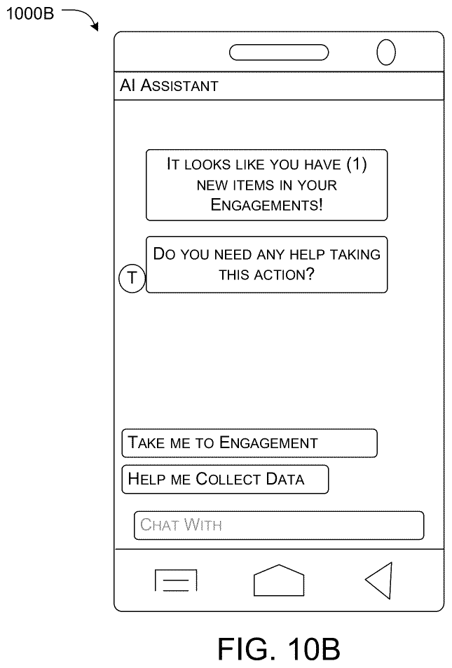

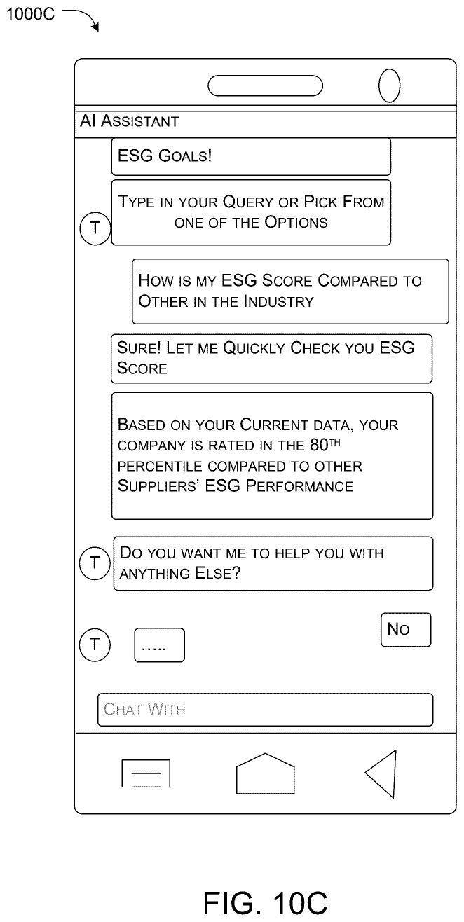

FIGS. 10A-10C collectively illustrates an exemplary AI assistant user interface 1000A, 1000B, and 1000C for the customer-supplier engagement, in accordance with embodiments of the present disclosure. The AI simulates human conversations with the target user or end-user. The AI assists customers or suppliers may provide requested details or information and alerts for pending tasks. The AI assistant may use for example, but not limited to, NLP (Natural language Processing) and NLU (Natural language Understanding) to understand user's questions and provide relevant responses. A chatbot may be used by many of the components listed above to generate the responses. The chatbot may provide an optional feedback option where a Thumbs Up and Thumbs Down icons are provided such that end user may respond if he is satisfied with the response provided or not. Also, the response generated may also include the source information from where the response is generated for reference.

A deep learning capability of the AI assistant may help the assistant to provide accurate responses over time as the assistant keeps learning from the conversations that occur. The deep learning may help the customers/suppliers to interact with the AI assistant in a more natural way with less chances of misunderstanding the questions. The interface may generate alerts in order to remind customers/suppliers regarding their pending tasks.

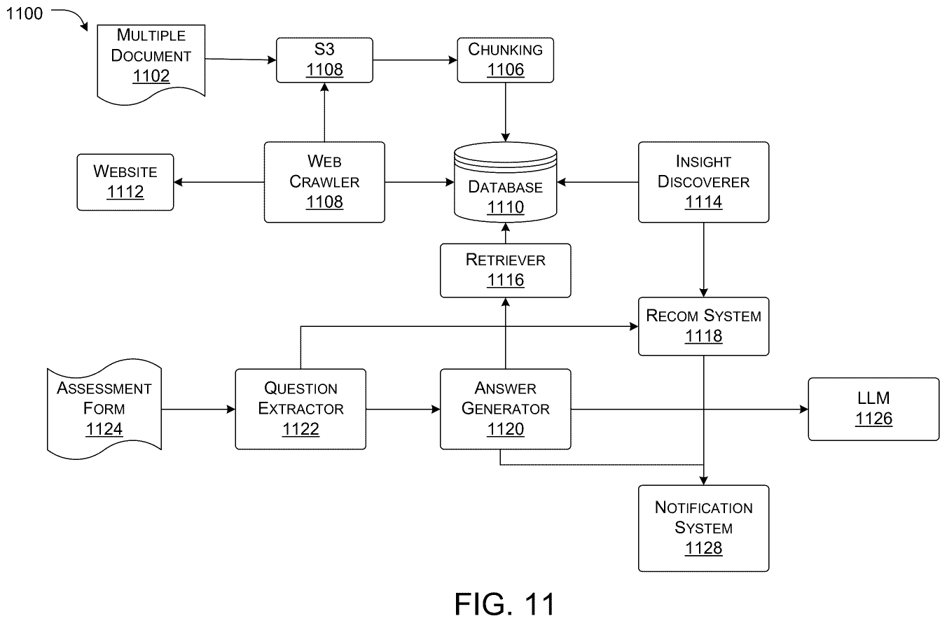

FIG. 11 illustrates an exemplary block diagram representation of the AI assistant copilot framework 1100 (also hereby referred as Agentic AI framework 1100), in accordance with embodiments of the present disclosure. The AI assistant copilot frame work 1100 may analyze the information related to a customer/supplier looking into various sources of information. The AI assistant copilot framework 1100 may include for example, but not limited to, web 1112 (also referred as website 1112), document repo 1102 (also referred as multiple document 1102), and database 1110, and the like. The web crawler 1108 may scan the web to find information such as documents, blogs, articles and the like. The scanned contents are uploaded to the S3 1108 bucket for further processing. The document repo 1102 may be directly uploaded to the S3 1108 bucket for further processing. The database 1110 may include data generated or imported into the database system may also be used by the copilot frame work.

In an embodiment, the AI assistant copilot framework 1100 may include a chunking 1106, an insight discoverer 1114, a retriever 1116, a recom system 1118, an answer generator 1120, a question extractor 1122, an assessment form 1124, a Large Language Model (LLM) 1126, and a notification system 1128.

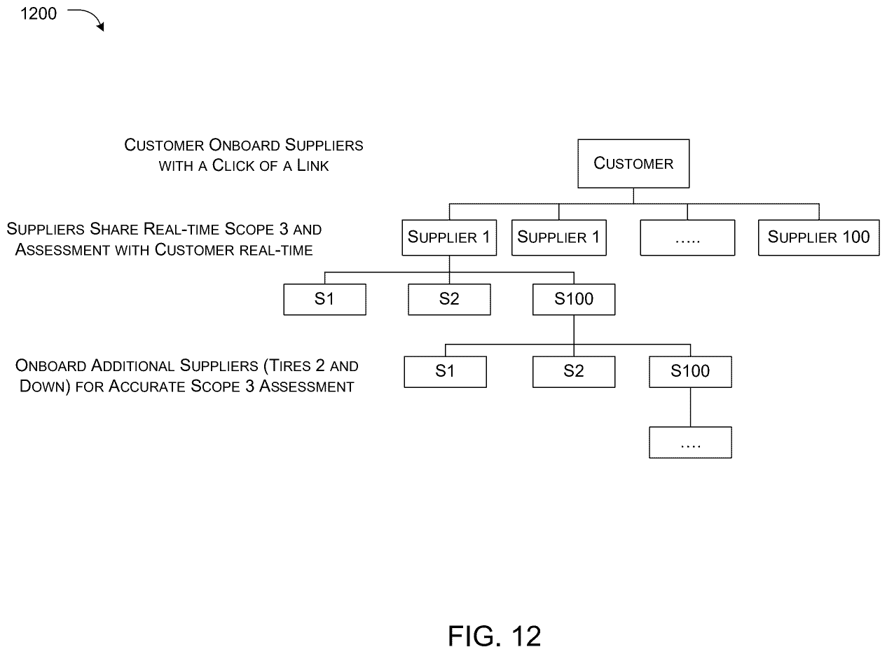

FIG. 12 illustrates an exemplary block diagram representation 1200 of a plurality of user for the customer-supplier engagement within the sustainability-focused enterprise, in accordance with embodiments of the present disclosure. In the customer-supplier engagement model, customers may involve their suppliers 106 to gather sustainability data, engage them in training, define target settings and then track them and the like. In the landlord tenant's engagement model, a landlord may involve their tenants from multi-family or multi-tenant properties. Here landlord may use the engagement model to gather their Utility data, engage them in policy definition by using questionnaires, involve them in trainings and the like. In the enterprise, entities engagement model, an enterprise may engage their entities in order to gather various standards or protocol specific data, involve them in training programs, set business related targets as well as track them, collect information related to labor practices and the like. In engagement model customers at different tier levels may engage their downstream suppliers to gather sustainability data, engage them in training, define target settings and then track them and the like.

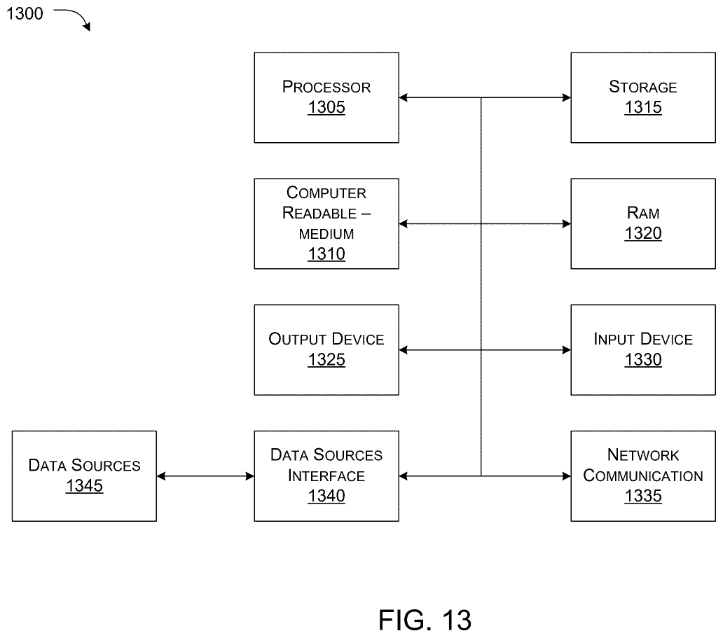

FIG. 13 is an exemplary block diagram representation of a hardware platform 1300 for implementation of the disclosed computer-implemented system 102, in accordance with embodiments of the present disclosure. Particularly, the computer-implemented system 102 such as but not limited to internal/external server clusters, quantum computers, desktops, laptops, smartphones, tablets, and wearables may be used to execute the computer-implemented system 102 or may include the structure of the hardware platform 1300. As illustrated, the hardware platform 1300 may include additional components not shown, and some of the components described may be removed and/or modified. For example, a computer system with multiple Graphics Processing Units (GPUs) may be located on external-cloud platforms including Amazon Web Services® (AWS), internal corporate cloud computing clusters, or organizational computing resources.

The hardware platform 1300 may be a computer system such as the computer-implemented system 102 that may be used with the embodiments described herein. The computer system may represent a computational platform that includes components that may be in a server or another computer system. The computer system may be executed by the processor 1305 (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., Random Access Memory (RAM), Read-Only Memory (ROM), Erasable, Programmable ROM (EPROM), Electrically Erasable, Programmable ROM (EEPROM), hard drives, and flash memory). The computer system may include the processor 1305 that executes software instructions or code stored on a non-transitory computer-readable storage medium 1310 (also referred as computer readable medium 1310) to perform methods of the present disclosure. The software code includes, for example, instructions to gather data and analyze the data.

The instructions on the computer-readable storage medium 1310 are read and stored the instructions in storage 1315 or random-access memory (RAM) 1320. The computer-readable storage medium 1310 may provide a space for keeping static data where at least some instructions could be stored for later execution. The stored instructions may be further compiled to generate other representations of the instructions and dynamically stored in the RAM such as RAM 1320. The processor 1305 may read instructions from the RAM 1320 and perform actions as instructed.

The computer system may further include the output device 1325 to provide at least some of the results of the execution as output including, but not limited to, visual information to users, such as external agents. The output device 1325 may include a display on computing devices and virtual reality glasses. For example, the display may be a mobile phone screen or a laptop screen. GUIs and/or text may be presented as an output on the display screen. The computer system may further include an input device 1330 to provide a user or another device with mechanisms for entering data and/or otherwise interacting with the computer system. The input device 1330 may include, for example, a keyboard, a keypad, a mouse, or a touchscreen. Each of these output devices 1325 and input device 1330 may be joined by one or more additional peripherals. For example, the output device 1325 may be used to display the results such as bot responses by the executable chatbot.

A network communicator 1335 (also referred as network communication) may be provided to connect the computer system to a network and in turn to other devices connected to the network including other clients, servers, data stores, and interfaces, for example. A network communicator 1335 may include, for example, a network adapter such as a LAN adapter or a wireless adapter. The computer system may include a data sources interface 1340 to access the data sources 1345. The data sources 1345 may be an information resource. As an example, a database of exceptions and rules may be provided as the data sources 1345. Moreover, knowledge repositories and curated data may be other examples of the data sources 1345.

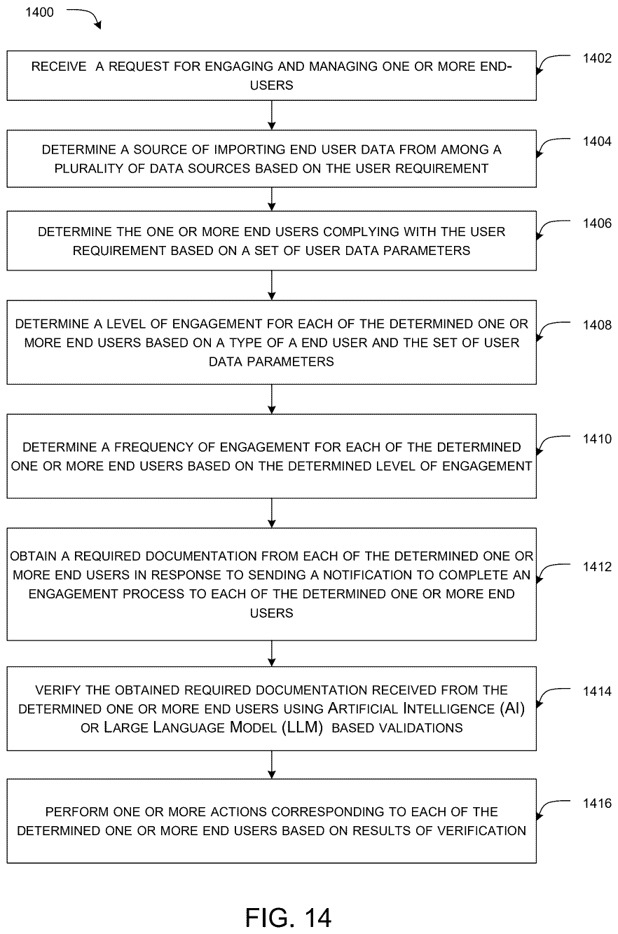

FIG. 14 is a flowchart illustrating a method 1400 for managing a customer-supplier engagement within a sustainability-focused enterprise, in accordance with embodiments of the present disclosure.

At block 1402, the method 1400 may include receiving, by a processor, a request for engaging and managing one or more target user or end-user. The request includes user requirements and user preferences. The user requirements may include Specifications or criteria provided by the enterprise or user that outline what they need from suppliers. For example, the user requirement may be “Suppliers with an ESG score above 80.”, “Manufacturers capable of delivering 10,000 units per month within a 30-day lead time.” And “Suppliers located within 500 km of our distribution center.”

The user preferences may include, such as but not limited to, suppliers ranked by proximity to specific warehouses or facilities, suppliers with specific ESG initiatives aligned with the enterprise's goals (e.g., net-zero emissions by 2030), preference for smaller, local suppliers over larger multinational corporations and the like. At block 1404, the method 1400 may include determining, by the processor, a source of importing supplier data from among a plurality of data sources based on the user requirement. The plurality of data sources includes one of external database, a locally stored database and a large language model based data source. The data sources may include, such as for example, but not limited to, External databases, Locally stored databases, or LLM-based data sources such as, for example, but not limited to, Large language models that extract insights from unstructured documents or reports.

At block 1406, the method 1400 may include determining, by the processor, the one or more suppliers complying with the user requirement based on a set of supplier data parameters. The set of supplier data parameters includes a tier association, a geographical location, a domain category, a current Environmental, Social, and Governance (ESG) score or sustainability score, a target year, and a priority tag. AI models, especially those designed for data integration, can consolidate information from multiple sources such as external databases, local storage, and large language model-based repositories. For instance, a supplier management system may use AI to automatically extract relevant supplier information from unstructured data sources like emails, PDFs, and reports. Natural Language Processing (NLP) algorithms powered by LLMs can parse textual content, identify key parameters (e.g., ESG scores, certifications), and structure it for downstream analysis. Data preprocessing models can then clean, deduplicate, and normalize this information, ensuring uniformity across diverse data formats. Machine Learning (ML) models, such as clustering and classification algorithms, can process supplier data to identify and categorize suppliers that meet specific requirements. For example, clustering models: group suppliers based on parameters like geographical location, tier association, or sustainability performance. Further, classification models may train supervised algorithms (e.g., Random Forest, Support Vector Machines (SVMs)) to predict supplier compliance with user-defined preferences, such as ESG targets or certification standards. By analyzing large datasets, AI can uncover patterns and insights that might be missed through manual processing, enabling enterprises to quickly identify optimal suppliers.

At block 1408, the method 1400 may include determining, by the processor, a level of engagement for each of the determined one or more suppliers based on a type of a supplier 106 and the set of supplier data parameters. The level of engagement includes assessments, a target setting and tracking, sustainability initiatives, an employee health and safety, labor practices, and trainings. AI models can use multi-objective optimization to calculate engagement levels and frequencies tailored to each supplier. For instance, predictive models such as time-series forecasting models may predict future supplier behavior, such as delivery reliability or ESG compliance trends, based on historical data, Further, optimization algorithms may use models which can balance multiple factors (e.g., supplier capacity, ESG scores, risk profiles) to recommend specific engagement activities, such as audits or training programs. Furthermore, reinforcement learning may further refine engagement schedules by adapting them dynamically based on real-time feedback, ensuring that resources are focused where they are most needed.

At block 1410, the method 1400 may include determining, by the processor, a frequency of engagement for each of the determined one or more suppliers based on the determined level of engagement.

At block 1412, the method 1400 may include obtaining, by the processor, a required documentation from each of the determined one or more suppliers in response to sending a notification to complete an engagement process to each of the determined one or more suppliers.

At block 1414, the method 1400 may include verifying, by the processor, the obtained required documentation received from the determined one or more suppliers using Artificial Intelligence (AI) or Large Language Model (LLM) based validations. AI-driven verification engines can automate the analysis of submitted documentation, reducing manual intervention and ensuring faster processing. Deep Learning Models use image recognition and document verification algorithms to validate scanned documents for authenticity (e.g., identifying tampered certificates). LLMs for Validation may Large language models which can parse unstructured text in ESG reports, extract relevant metrics, and cross-check these against predefined benchmarks. For instance, LLMs can flag inconsistencies in carbon emission data or missing elements in a compliance report. Anomaly Detection Models: may use unsupervised learning models which can identify irregularities, such as unusually low ESG scores or discrepancies in financial reports, signaling potential risks.

At block 1416, the method 1400 may include performing, by the processor, one or more actions corresponding to each of the determined one or more suppliers based on results of verification.

AI models excel in tracking and updating supplier performance metrics over time. Time-Series Models such as Predictive analytics can forecast trends in ESG scores or other sustainability metrics based on historical data. Feedback Loops such as AI systems which can incorporate feedback from audits and supplier interactions to continuously improve performance predictions. AI-powered visualization tools can process vast datasets and generate real-time dashboards that summarize supplier performance, compliance, and engagement effectiveness.

The method 1400 may be implemented in any suitable hardware, software, firmware, or combination thereof. The order in which the method 1400 is described is not intended to be construed as a limitation, and any number of the described method blocks may be combined or otherwise performed in any order to implement the method 1400 or an alternate method. Additionally, individual blocks may be deleted from the method 1400 without departing from the spirit and scope of the present disclosure described herein. Furthermore, the method 1400 may be implemented in any suitable hardware, software, firmware, or a combination thereof, that exists in the related art or that is later developed. The method 1400 describes, without limitation, the implementation of the computer-implemented system 102. A person of skill in the art may understand that method 1400 may be modified appropriately for implementation in various manners without departing from the scope and spirit of the disclosure.

In an example embodiment, the inputs include unstructured text, tabular data, and scanned images of documents. The LLM Processing includes Tokenization. LLMs break down text into smaller units (tokens). For example, “ESG score: 85/100” is tokenized for semantic understanding. The model converts tokens into vector representations in a multi-dimensional space, capturing the context of the information. The LLM uses its weights (parameters trained on large corpora) to extract structured information from unstructured data, such as ESG scores or regulatory compliance metrics.

For tabular or structured data, normalization and feature scaling ensure inputs are consistent. For images, preprocessing (e.g., Optical Character Recognition (OCR) for text extraction) converts them into formats usable by AI models.

Weights are numerical values within the AI model that adjust how input features influence the output. For example, in a neural network, input features (e.g., supplier ESG scores, location, or financial data) are multiplied by weights, and these weighted sums are passed through activation functions (e.g., ReLU or sigmoid) to calculate predictions. Weights are updated during training using optimization algorithms such as for example, Stochastic Gradient Descent (SGD) or Adam. For supervised learning models, loss functions (e.g., Mean Squared Error or Cross-Entropy Loss) quantify prediction errors, guiding weight adjustments during backpropagation. The LLM Outputs include extracted key metrics, summarized compliance reports, or action recommendations. Further, the AI models predict compliance categories (e.g., compliant, partially compliant, non-compliant) and detect anomalies.

Furthermore, the LLM models generate structured reports: “Supplier X meets ESG standards but lacks required certification.”, suggest actions: “Request additional documentation from Supplier Y.” The AI Model Outputs include classification Output: Assign suppliers a compliance score or risk category, Anomaly Detection: Highlight unusual patterns in financial or ESG data. Further, the system 102 automatically sends notification to Integrate with communication systems to request missing documents or escalate issues. The system 102 may approve or reject suppliers based on scores, initiate audits, or update supplier status in the database

The present disclosure provides a customer-supplier auto engagement platform which may in a periodic way, engage the supplier in a multitude of ways to gather data, involve in training programs, define targets and track them. Further, the present disclosure provides AI agents to help suppliers enter data and fill assessments. Further, the present disclosure supports multi-use cases like customer—supplier, landlord—tenant, customer—entity, and multi-tiered tenant model.

The present disclosure provides an end-to-end solution that allows a company to accelerate and focus their climate and sustainability efforts with out-of-the-box data integrations, GHG Emissions (Scopes 1,2,3), water and waste tracking and measurement, social and governance KPI data tracking, AI-powered predictions and recommendations, reporting in compliance with multiple frameworks and regulations, and AI-powered supplier sustainability platform.

The present disclosure provides out-of the box data integrations with multiple industry leading systems such as SAP, Oracle, Salesforce, Workday, Microsoft and IoT systems that enables the importing and use of existing enterprise data sources.

The present disclosure provides powered data collection, combined with existing GHG and ESG data calculators, and enables an enterprise to calculate and track GHG emissions (scopes 1, 2 & 3), Environmental, Social and Governance (ESG) data for both the enterprise and its suppliers.

The present disclosure allows customers for seamless and auditable climate and sustainability reporting in compliance with multiple frameworks and jurisdictions. Further, the present disclosure supports enterprises on their sustainability journey as they both achieve their near-term goals and drive towards greater levels of sustainability leadership by efficiently engaging their suppliers, partners and employees to create transformational sustainable products and services.

The present disclosure provides a dashboard view which helps customers get insights about supplier data in various forms of charts. The dashboard includes charts such as summary view, global heat map, supplier employee health and safety incident chart, supplier's New Letter, and QBR Chart.

The present disclosure streamlines supplier engagement for corporate sustainability initiatives. The computer implemented system of the present disclosure is designed to streamline and automate the process of sustainability reporting and supplier engagement. Further, the present disclosure collects and analyzes supplier sustainability data, including carbon footprint and ESG metrics.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein may comprise hardware and software elements. The embodiments that are implemented in software include but are not limited to, firmware, resident software, microcode, and the like. The functions performed by various modules described herein may be implemented in other modules or combinations of other modules. For the purposes of this description, a computer-usable or computer-readable may be any apparatus that may comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the disclosure. When a single device or article is described herein, it may be apparent that more than one device/article (whether or not they cooperate) may be used in place of a single device/article. Similarly, where more than one device or article is described herein (whether or not they cooperate), it may be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

The illustrated steps are set out to explain the exemplary embodiments shown, and it should be anticipated that ongoing technological development may change the manner in which particular functions are performed. These examples are presented herein for purposes of illustration, and not limitation. Further, the boundaries of the functional building blocks have been arbitrarily defined herein for the convenience of the description. Alternative boundaries may be defined so long as the specified functions and relationships thereof are appropriately performed. Alternatives (including equivalents, extensions, variations, deviations, and the like, of those described herein) may be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a”, “an”, and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the embodiments of the present disclosure are intended to be illustrative, but not limited, of the scope of the disclosure, which is outlined in the following claims.

What is claimed is:

1. A computer-implemented system for managing a end-user engagement within a sustainability-focused enterprise, comprising:
a processor; and
a memory communicably coupled to the processor, wherein the memory comprises processor-executable instructions which, when executed by the processor, cause the processor to:
receive a request for engaging and managing one or more target user or end-user, wherein the request comprises user requirements and user preferences;
determine a source of importing end-user data from among a plurality of data sources based on the user requirements, wherein the plurality of data sources comprise one of external database, a locally stored database and a large language model based data source;
determine the one or more end-users complying with the user requirements based on a set of end-user data parameters, wherein the set of end-user data parameters comprise a tier association, a geographical location, a domain category, a current Environmental, Social, and Governance (ESG) score or sustainability score, a target year, and a priority tag;
determine a level of engagement for each of the determined one or more end-users based on a type of an end-user and the set of end-user data parameters, wherein the level of engagement comprises assessments, a target setting and tracking, sustainability initiatives, an employee health and safety, labor practices, and trainings;
determine a frequency of engagement for each of the determined one or more end-users based on the determined level of engagement;
obtain a required documentation from each of the determined one or more end-users in response to sending a notification to complete an engagement process to each of the determined one or more end-users;
verify the obtained required documentation received from the determined one or more end-users using Artificial Intelligence (AI) or Large Language Model (LLM) based validations; and
perform one or more actions corresponding to each of the determined one or more end-users based on results of verification.

2. The computer-implemented system of claim 1, wherein to obtain the required documentation from each of the determined one or more end-users, the processor is configured to:
obtain a supply chain data associated with the determined one or more end-users; and
determine a product-level emission factor associated with the determined one or more end-users by assessing the obtained supply chain data.

3. The computer-implemented system of claim 1, wherein the one or more actions comprise:
track one of an emissions data, assess product life cycle, assess materiality, share assessments and reports with end-users, and track product-level emissions factors.

4. The computer-implemented system of claim 3, wherein to track and calculate the emissions data, the processor is configured to:
determine corresponding emission value of the end-users by analyzing at least one of a water usage, a waste generation, stationary combustion sources, and purchased gases.

5. The computer-implemented system of claim 1, wherein the one or more actions comprise:
extract one or more end-user inputs for inclusion in sustainability assessments based on the obtained required documentation; and
interpret the extracted one or more end-user inputs and generate automated responses to the extracted one or more end-user inputs by deploying one or more AI agents, wherein the extracted one or more end-user inputs are interpreted by the one or more AI agents using one of a natural language processing model and a natural language understanding model.

6. The computer-implemented system of claim 1, further comprising an end-user device comprising a processor is configured to:
receive a notification to complete the engagement process, wherein the notification comprises a set of questionnaire related to the end-user;
determine an information required for responding to the set of questionnaire related to the end-user by parsing the received notification using large language models;
automate responses to the set of questionnaire based on the determined information using an artificial intelligence assisted system; and
send an auto-populated responses as the required documentation to the user.

7. The computer-implemented system of claim 1, wherein the one or more actions comprise:
generate and display one or more visual representations representing geographical distribution and concentration of a plurality of end-users;
generate a location-based risk score associated with each of the plurality of end-users based on a generated global heat map; and
tune the level of engagement for each of the determined one or more end-users based on the generated location-based risk score.

8. The computer-implemented system of claim 1, wherein the one or more actions comprise:
customize the level of engagement with the plurality of end-users based on a type of the end-user.

9. The computer-implemented system of claim 1, wherein the one or more actions comprise:
validate whether the plurality of end-users comply with at least one of ESG regulations and enterprise regulations by evaluating performance of each of the plurality of end-users; and
customize the level of engagement with the plurality of end-users based on results of validation.

10. The computer-implemented system of claim 1, wherein the one or more actions comprise:
receive an Environmental, Social, and Governance (ESG) data or sustainability data from the plurality of end-users;
generate at least one of an AI-powered predictions, recommendations, and scenario based insights on the received ESG or sustainability data;
define sustainability goals and decarbonization targets for each of the plurality of end-users using the generated at least one AI-powered predictions, and the recommendations; and
assess Key Performance Indicators (KPIs) for each of the plurality of end-users based on the defined sustainability goals and decarbonization targets.

11. A computer-implemented method for managing a customer-end-user engagement within a sustainability-focused enterprise, comprising:
receiving, by a processor, a request for engaging and managing one or more target user or end-user, wherein the request comprises user requirements and user preferences;
determining, by the processor, a source of importing end-user data from among a plurality of data sources based on the user requirements, wherein the plurality of data sources comprise one of external database, a locally stored database and a large language model based data source;
determining, by the processor, the one or more end-users complying with the user requirements based on a set of end-user data parameters, wherein the set of end-user data parameters comprise a tier association, a geographical location, a domain category, a current Environmental, Social, and Governance (ESG) or sustainability score, a target year, and a priority tag;
determining, by the processor, a level of engagement for each of the determined one or more end-users based on a type of an end-user and the set of end-user data parameters, wherein the level of engagement comprises assessments, a target setting and tracking, sustainability initiatives, an employee health and safety, labor practices, and trainings;
determining, by the processor, a frequency of engagement for each of the determined one or more end-users based on the determined level of engagement;
obtaining, by the processor, a required documentation from each of the determined one or more end-users in response to sending a notification to complete an engagement process to each of the determined one or more end-users;
verifying, by the processor, the obtained required documentation received from the determined one or more end-users using Artificial Intelligence (AI) or Large Language Model (LLM) based validations; and
performing, by the processor, one or more actions corresponding to each of the determined one or more end-users based on results of verification.

12. The computer-implemented method of claim 11, wherein obtaining the required documentation from each of the determined one or more end-users comprises:
obtaining, by the processor, a supply chain data associated with the determined one or more end-users; and
determining, by the processor, a product-level emission factor associated with the determined one or more end-users by assessing the obtained supply chain data.

13. The computer-implemented method of claim 11, wherein the one or more actions comprise:
tracking and calculating, by the processor, one of an emissions data, assessing product life cycle, assessing materiality, sharing assessments and reports with end-users, and track product-level emissions factors, wherein the emissions data is calculated by determining corresponding emission value of an end-user by analyzing at least one of a water usage, a waste generation, stationary combustion sources, and purchased gases.

14. The computer-implemented method of claim 11, wherein the one or more actions comprise:
extracting, by the processor, one or more end-user inputs for inclusion in sustainability assessments based on the obtained required documentation; and
interpreting, by the processor, the extracted one or more end-user inputs and generating automated responses to the extracted one or more end-user inputs by deploying one or more AI agents, wherein the extracted one or more end-user inputs are interpreted by the one or more AI agents using one of a natural language processing model and a natural language understanding model.

15. The computer-implemented method of claim 11, further comprising:
receiving, by a processor of an end-user device, a notification to complete the engagement process, wherein the notification comprises a set of questionnaire related to the end-user;
determining, by the processor of the end-user device, an information required for responding to the set of questionnaire related to the end-user by parsing the received notification using large language models;
auto-populating, by the processor of the end-user device, responses to the set of questionnaire based on the determined information using an artificial intelligence assisted system; and
sending, by the processor of the end-user device, the auto-populated responses as the required documentation to the user.

16. The computer-implemented method of claim 11, wherein the one or more actions comprise:
generating and displaying, by the processor, one or more visual representations representing geographical distribution and concentration of a plurality of end-users;
generating, by the processor, a location-based risk score associated with each of the plurality of end-users based on the generated global heat map; and
tuning, by the processor, the level of engagement for each of the determined one or more end-users based on the generated location-based risk score.

17. The computer-implemented method of claim 11, wherein the one or more actions comprise:
customizing, by the processor, the level of engagement with the plurality of end-users based on a type of the end-user.

18. The computer-implemented method of claim 11, wherein the one or more actions comprise:
validating, by the processor, whether the plurality of end-users comply with at least one of ESG regulations and enterprise regulations by evaluating performance of each of the plurality of end-users; and
customizing, by the processor, the level of engagement with the plurality of end-users based on results of validation.

19. The computer-implemented method of claim 11, wherein the one or more actions comprise:
receiving, by the processor, Environmental, Social, and Governance (ESG) data or sustainability data from the plurality of end-users;
generating, by the processor, at least one of an AI-powered predictions, recommendations, and scenario based insights on the received ESG or sustainability data;
defining, by the processor, sustainability goals and decarbonization targets for each of the plurality of end-users using the generated at least one AI-powered predictions, and the recommendations; and
assessing, by the processor, Key Performance Indicators (KPIs) for each of the plurality of end-users based on the defined and sustainability goals and decarbonization targets.

20. A non-transitory computer readable medium comprising a processor-executable instructions that cause a processor to:
receive a request for engaging and managing one or more target user or end-user, wherein the request comprises user requirements and user preferences;
determine a source of importing end-user data from among a plurality of data sources based on the user requirements, wherein the plurality of data sources comprise one of external database, a locally stored database and a large language model based data source;
determine the one or more end-users complying with the user requirements based on a set of end-user data parameters, wherein the set of end-user data parameters comprise a tier association, a geographical location, a domain category, a current Environmental, Social, and Governance (ESG) score or sustainability score, a target year, and a priority tag;
determine a level of engagement for each of the determined one or more end-users based on a type of an end-user and the set of end-user data parameters, wherein the level of engagement comprises assessments, a target setting and tracking, sustainability initiatives, an employee health and safety, labor practices, and trainings;
determine a frequency of engagement for each of the determined one or more end-users based on the determined level of engagement;
obtain a required documentation from each of the determined one or more end-users in response to sending a notification to complete an engagement process to each of the determined one or more end-users;
verify the obtained required documentation received from the determined one or more end-users using Artificial Intelligence (AI) or Large Language Model (LLM) based validations; and
perform one or more actions corresponding to each of the determined one or more end-users based on results of verification.
